(19) United States
(12) Patent Application Publication
(10) Pub. No.: US 2025/0215195 A1
(43) Pub. Date: Jul. 3, 2025

(54) SUSTAINABLE APPROACH TO DEVELOP MULTIFUNCTIONAL COMPOSITES WITH ENHANCED PROPERTIES

(71) Applicant: SAUDI ARABIAN OIL COMPANY, Dhahran (SA)

(72) Inventors: Aziz Fihri, Paris (FR); Yassine Malajati, Beachwood, OH (US); Waleed Al Nasser, Dammam (SA); Hawraa Bin Saad, Dhahran (SA); Layla Alfadel, Qatif (SA); Noor Alsakhin, Dhahran (SA)

(73) Assignee: SAUDI ARABIAN OIL COMPANY, Dhahran (SA)

(21) Appl. No.: 18/400,933

(22) Filed: Dec. 29, 2023

(51) Int. Cl. C08K 9/06; C09C 1/30; C09C 3/12

(52) U.S. Cl. CPC C08K 9/06; C09C 1/3081; C09C 3/12; C08K 2201/003

(57) ABSTRACT

A functionalized inorganic filler includes an inorganic particle which includes a surface functionality. The surface functionality is at least one amine group linked to a surface of the inorganic particle. The functionalized inorganic filler is formed from a reaction between an inorganic particle and an aminosilane compound. A method of making a functionalized inorganic filler includes providing inorganic particles with at least one aminosilane compound to form a reactive mixture and agitating the reactive mixture to form the functionalized inorganic filler. A polymer composite includes an epoxy-based polymer matrix and the functionalized inorganic filler. A reinforced thermoset composite pipe includes the polymer composite.

### BACKGROUND

Epoxy resins are an important class of thermosetting polymers, containing more than one epoxy group capable of reacting with suitable curing agents to form highly crosslinked/three-dimensional networks after curing. Other constituents such as catalysts, fillers, or diluents may be included in the formulation to modify certain properties of the thermoset material. Because of their unique structures, epoxies exhibit superior properties including high mechanical strength, high adhesive strength, low shrinkage, good chemical resistance, and good electrical insulation properties, among others. These properties enable epoxy resins to have a widespread use in different applications such as coatings, adhesives, composites, etc., and for different sectors including building and construction, automotive, aerospace, electronics, renewable energy (e.g. wind turbines, rotor blades, etc.).

However, the highly crosslinked nature of epoxies causes them to be relatively brittle and stiff, with poor resistance to crack initiation and growth and hence low toughness and impact resistance. This inherent brittleness and low toughness are indeed one of the major drawbacks of epoxy resins limiting their use in a number of applications, particularly structural applications. In epoxy-based composites such as carbon fiber- or glass fiber reinforced plastics (CFRP and GFRP), minor impacts, especially transverse impacts, can result in very small defects and damages known as barely visible damages (BVD), that may lead to debonding and delamination issues. If not properly addressed, these issues can cause serious safety concerns and may lead to dramatic failures, especially in safety-sensitive industries such as aeronautics, defense, oil and gas, etc.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a functionalized inorganic filler which includes an inorganic particle including a surface functionality. The surface functionality is at least one amine group linked to a surface of the inorganic particle. The functionalized inorganic filler is formed from a reaction between an inorganic particle and an aminosilane compound.

In another aspect, embodiments disclosed herein relate to a method of making a functionalized inorganic filler, which includes providing inorganic particles with at least one aminosilane compound to form a reactive mixture and agitating the reactive mixture to form the functionalized inorganic filler.

In yet another aspect, embodiments disclosed herein relate to a polymer composite which includes an epoxy-based polymer matrix and a functionalized inorganic filler which includes an inorganic particle which includes a surface functionality. The surface functionality is at least one amine group linked to a surface of the inorganic particle. The functionalized inorganic filler is formed from a reaction between an inorganic particle and an aminosilane compound.

In yet another aspect, embodiments disclosed herein relate to a reinforced thermoset composite pipe which includes a polymer composite.

Other aspects and advantages of the claimed subject matter will be apparent from the following description and the appended claims.

### BRIEF DESCRIPTION OF DRAWINGS

FIG. 1 is a block flow diagram outlining a method of making a functionalized inorganic filler in accordance with one or more embodiments of the present disclosure.

FIG. 2 is a reaction scheme for making the functionalized inorganic filler in accordance with one or more embodiments of the present disclosure.

FIG. 3 is a reaction scheme for making the cyclic carbonate inorganic filler in accordance with one or more embodiments of the present disclosure.

FIG. 4 is a schematic of the formation and structure of an epoxy-based polymer composite containing functionalized inorganic filler in accordance with one or more embodiments of the present disclosure.

FIG. 5 is a schematic of the formation and structure of an epoxy-based polymer composite resulting from the reaction of cyclic carbonate inorganic filler and epoxy resin with amine functionalized inorganic filler and curing agent in accordance with one or more embodiments of the present disclosure.

### DETAILED DESCRIPTION

The present disclosure generally relates to toughening agents and rigid inorganic fillers for epoxy resins. Such fillers and toughening agents may enhance the toughness of polymer materials, such as epoxy-based polymers, without adversely affecting their thermo-mechanical properties. The effectiveness of these particulate fillers may be a result of a number of parameters, including their shape, concentration, size, and composition, among others. In one or more embodiments of the present disclosure, the particle size of the fillers is particularly important. For example, relatively large particles may considerably increase the viscosity of epoxy resins, causing processability issues inevitably limiting the use of such composites in certain processes and applications. Thus, relatively small fillers, such as fillers of the nanoscale, may be used for enhanced processability.

Embodiments of the present disclosure generally relate to a functionalized inorganic filler composition, a method of forming the functionalized inorganic filler, and a polymer composite composition incorporating the functionalized inorganic filler. In one or more embodiments, the functionalized inorganic filler may include a surface functionalization of the inorganic material. The polymer composites of one or more embodiments may have enhanced toughness and good processability.

### Functionalized Inorganic Filler Composition

As noted above, the present disclosure relates to a functionalized inorganic filler. In one or more embodiments, the functionalized inorganic filler may include an inorganic material. The inorganic material may be a plurality of inorganic particles. The inorganic particles may be selected from the group consisting of silica, titanium dioxide, zinc oxide, zirconium dioxide, and combinations thereof. In one or more particular embodiments, the inorganic particle may be silica.

The plurality of inorganic particles (or “inorganic particles”) of one or more embodiments may include particles of different shapes, meaning they may be non-uniform shapes. In such embodiments, the inorganic particles may be core-shell particles, hollow particles, and/or solid particles. In one or more particular embodiments, the plurality of inorganic particles may have a defined shape. In such embodiments, the defined shape of the inorganic particles may include shapes selected from the group consisting of spheres, tubes, lamellas, rods, dendrites, bristle-like, fibers, and combinations thereof. The inorganic particles according to one or more embodiments of the present disclosure may have a spherical shape.

In one or more embodiments, the inorganic particles may have an average size. As described herein, the average particle size refers to the average diameter of the particles as measured by electron microscopy such as transmission electron microscopy (TEM), scanning electron microscopy (SEM), or dynamic light scattering (DLS). In such embodiments, the average diameter of the inorganic particles may be in a range of 15 to 500 nm (nanometers). The average diameter of the inorganic particles may have a lower limit of one of 15, 20, 25, 50, 75 and 100 nm and an upper limit of one of 100, 200, 300, 400, and 500 nm, where any lower limit may be paired with any mathematically upper limit.

As noted above, the functionalized inorganic filler may include inorganic particles including a particular surface functionality. In one or more embodiments, the surface functionality of the inorganic particles may be amine groups. The surface functionality of the inorganic particles of one or more embodiments may include at least one aminosilane compound chemically linked to the surface of the inorganic particles. In such embodiments, the aminosilane compound may be selected from the group consisting of 4-amino-3,3-dimethylbutyl trimethoxysilane, m-aminophenyl trimethoxysilane, 3-aminopropyl triethoxysilane and 3-(m-aminophenoxy) propyl trimethoxysilane.

In one or more embodiments, the functionalized inorganic filler may be used as a component in polymer composites. When using functionalized inorganic fillers in polymer composites, the functionalized inorganic filler which bears amine groups may be used in conjunction with cyclic carbonate inorganic fillers, however the cyclic carbonate inorganic fillers are not required. The cyclic carbonate inorganic fillers are described in greater detail below.

### Method of Forming a Functionalized Inorganic Filler

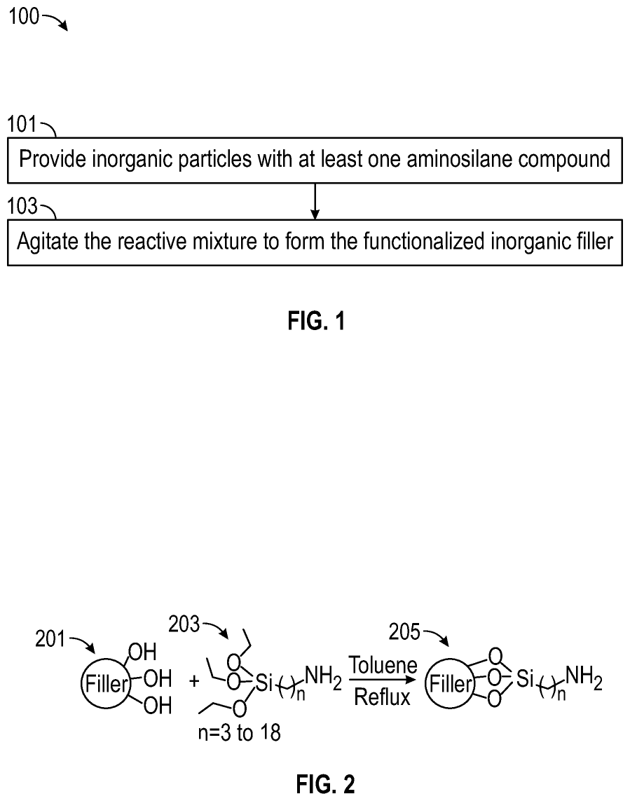

Embodiments of the present disclosure also relate to a method 100 of making the previously described functionalized inorganic filler (FIG. 1). The method includes step 101 of providing inorganic particles with at least one aminosilane compound to form a reactive mixture. In such embodiments, prior to providing the inorganic particles to form the reactive mixture, the inorganic particles may be prepared via a hydrothermal process or obtained commercially. Any suitable hydrothermal method known in the art may be used to prepare the inorganic particles. The method further includes step 103, which includes agitating and refluxing the reactive mixture to form the functionalized inorganic filler. The inorganic particles, the aminosilane compound, and the functionalized inorganic filler may be as described above.

In such embodiments, the inorganic particles may be dispersed in a solvent for a period of time prior to combining them with the at least one aminosilane compound. The inorganic particles may be added to the solvent in an amount of 5 to 25 wt % (weight percent) based on the total weight of the solvent. For example, in one or more embodiments, the inorganic particles may be included in an amount ranging from a lower limit of one of 5, 8, 10, 12, and 15 wt % to an upper limit of one of 15, 18, 20, 22, and 25 wt %, where any lower limit may be paired with any mathematically compatible upper limit. The inorganic particles may be dispersed using a method known to those skilled in the art, such as sonication, agitation, mechanical mixing, and combinations thereof. The solvent may be an organic solvent. The organic solvent may be a carbon-based solvent, such as a non-polar solvent, a polar solvent, and combinations thereof, that is capable of dissolving and/or dispersing at least one other substance. In one or more particular embodiments, the organic solvent may be a hydrocarbon solvent, such as toluene.

In one or more embodiments, the inorganic particles may be functionalized by chemically linking the at least one aminosilane compound described above to the surface of the inorganic particle. This may be achieved by agitating and refluxing the reactive mixture that includes the at least one aminosilane compound and the dispersed inorganic particles in step 103. The at least one aminosilane compound may be present in the mixture in an amount in a range from about 5 to 25 wt % based on the amount of inorganic particles. For example, in one or more embodiments, the at least one aminosilane compound may be present in the mixture in an amount ranging from a lower limit of one of 5, 8, 10, 12, and 15 wt % to an upper limit of one of 15, 18, 20, 22 and 25 wt %, where any lower limit may be paired with any mathematically compatible upper limit.

In step 103, the mixture may be agitated via mechanical mixing, blending, or any other agitation method known to those skilled in the art to promote the formation of the functionalized inorganic filler. In one or more embodiments, the agitation may stimulate the mixture such that a linker group of the at least one aminosilane compound may chemically link (or form a bond) to a reactive group on the surface of the inorganic particles. In such embodiments, the temperature of the reaction mixture may be elevated or decreased for an amount of time. For example, the reaction mixture may be heated to reflux.

A reaction scheme in accordance with the previously described method of making the functionalized inorganic filler is presented in FIG. 2. In this regard, silica particles 201 with hydroxyl groups on the surface may react with an aminosilane compound 203. Silica particles 201 may be dispersed in a solvent such as dry toluene via stirring at room temperature for a period of time, such as 30 minutes. Then the aminosilane compound 203 may be added dropwise. A functionalized inorganic filler 205 may be obtained after agitating and refluxing the reaction mixture in toluene for a period of time. The functionalized inorganic filler 205 may then be isolated, washed, and dried using methods known to those skilled in the art.

### Composition of Polymer Composite

Polymer composites of one or more embodiments may include at least one functionalized inorganic filler, at least one epoxy resin, and at least one curing agent. As used in this disclosure, the term “polymer composites” refers to a combination of polymeric materials, fillers, curing agents, and optional additives. The term “polymeric materials” refers to existing polymers, constituents that react to form polymers (such as monomers and oligomers), and combinations thereof. The constituents that react to form polymers may include but are not limited to epoxy resins, fillers, and curing agents. The fillers may include the functionalized inorganic fillers of one or more embodiments described above.

In one or more embodiments, the polymer composite may be an epoxy resin-based composite. The epoxy resins may be mixed in an amount of the epoxy resin sufficient to form a cured epoxy composition. For example, the epoxy resin system may include from about 50 wt. % (weight percent) to about 98 wt. % of epoxy resin based on the total weight of the polymer composite before curing. The epoxy resin may have a lower limit of one of 50, 55, 60, 65, and 70 wt. %, and an upper limit of one of 75, 80, 85, 90, 95, and 98 wt. %, of the polymer composite, where any lower limit may be paired with any upper limit.

Examples of suitable epoxy resins include, but are not limited to, bisphenol-A-based epoxy resins, bisphenol-F-based epoxy resins, aliphatic epoxy resins, aromatic epoxy resins, Novalac resins, and combinations thereof. Aliphatic and aromatic epoxy resins may include glycidyl ethers and diglycidyl ethers. Glycidyl ethers may include alkyl glycidyl ethers, aromatic glycidyl ethers, or both. Glycidyl ethers have a chemical structure as shown in Formula (I):

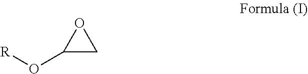

where R may be a linear, branched, cyclic, or aromatic hydrocarbon group having from 4 to 24 carbon atoms. As used throughout this disclosure, the term “hydrocarbon group” refers to branched, straight chain, and/or ring-containing hydrocarbon groups, which may be saturated or unsaturated. The hydrocarbon groups may be primary, secondary, and/or tertiary hydrocarbons. In one or more embodiments, the hydrocarbon group may be a substituted hydrocarbon group (as defined above) where at least one hydrogen atom is replaced with a non-hydrogen group that results in a stable compound. Such substituents may be groups selected from, but are not limited to, halo, hydroxyl, alkoxy, oxo, alkanoyl, aryloxy, alkanoyloxy, amino, alkylamino, arylamino, arylalkylamino, disubstituted amines, alkanylamino, aroylamino, aralkanoylamino, substituted alkanoylamino, substituted arylamino, aubstituted aralkanoylamino, thiol, alkylthio, arylthio, arylalkylthio, alkylthiono, arylthiono, aryalkylthiono, alkylsulfonyl, arylsulfonyl, arylalkylsulfonyl, sulfonamide, substituted sulfonamide, nitro, cyano, carboxy, carbamyl, alkoxycarbonyl, aryl, substituted aryl, guanidine, vinyl, acetylene, acrylate, cyanate, epoxide, and heterocyclyl groups, and mixtures thereof. The hydrocarbon group may have a lower limit of one of 4, 6, 8, 10, and 12 carbon atoms, and an upper limit of one of 12, 14, 16, 18, 20, 22, and 24 carbon atoms, where any lower limit may be paired with any upper limit. In some embodiments, R may include one or more substituted or unsubstituted aromatic rings. In some embodiments, the epoxy resin may include C12-C14 alkyl glycidyl ethers, butyl glycidyl ether, 2,3-epoxypropyl-o-tolyl ether, or combinations of these. Diglycidyl ethers have chemical structure as shown in Formula (II):

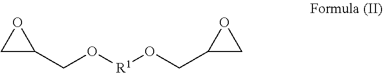

where R¹ may be a linear, branched, cyclic, or aromatic hydrocarbyl having from 4 to 24 carbon atoms. The RI group may have a lower limit of one of 4, 6, 8, 10, and 12 carbon atoms, and an upper limit of one of 12, 14, 16, 18, 20, 22, and 24 carbon atoms, where any lower limit may be paired with any upper limit. In one or more embodiments, RI may include one or more substituted or unsubstituted aromatic rings. In one or more embodiments, R¹ may be an alkyl group or cycloalkyl group. For example, the epoxy resin may include 1,6-hexanediol diglycidyl ether, which has chemical structure as shown in Formula (III):

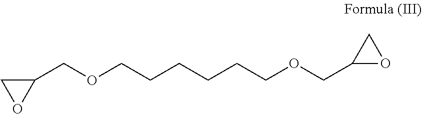 [SMILES: C(CCCOCC1CO1)CCOCC1CO1]

Non-limiting examples of the epoxy resin of one or more embodiments may be selected from the group consisting of diglycidyl ether of bisphenol A, diglycidyl ether of bisphenol F, epoxy phenol novolac resins, and combinations thereof. In one or more particular embodiments, the epoxy resin may be bisphenol-A-diglycidyl ether (DGEBA), as shown in Formula (IV)

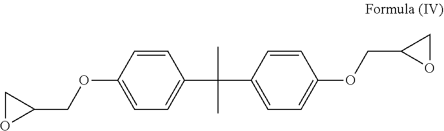 [SMILES: CC(C)(c1ccc(OCC2CO2)cc1)c1ccc(OCC2CO2)cc1]

The functionalized inorganic filler may be included in the polymer composite in an amount ranging from 0.1 to 30 wt. % based on the amount of epoxy resin. The functionalized inorganic filler may be included in an amount having a lower limit of one of 0.1, 0.25, 0.5, 1.0, 2.0, 5.0, 10, and 15 wt. % and an upper limit of one of 10, 12.5, 15, 20, 25, 27.5 and 30 wt. %, where any lower limit may be paired with any mathematically compatible upper limit.

The curing agent may be an amine curing agent. The curing agent may include at least one amine group. The term “amine” as used refers to primary, secondary, and tertiary amines having, for example, the formula N (group) 3, where each ‘group’ can independently be H or non-H, such as alkyl and aryl. Amines include, but are not limited to, R—NH₂, for example, alkylamines, arylamines, alkylarylamines; R₂NH, where each R is independently selected, such as dialkylamines, diarylamines, arylalkylamines, and heterocyclylamines; and R₃N, where each R is independently selected, such as trialkylamines, dialkylarylamines, alkyldiarylamines, and triarylamines. The term “amine” also includes ammonium ions as used.

Curing agents with amine functional groups may include, but are not limited to, an amine, polyamine, amine adduct, polyamine adduct, alkanolamine, phenalkamines, or a combination of these. Examples of amine or polyamine curing agents may include, but are not limited to, aliphatic amines; cycloaliphatic amines; modified cycloaliphatic amines, such as cycloaliphatic amines modified by polyacrylic acid; aliphatic polyamines; cycloaliphatic polyamines; modified polyamines, such as polyamines modified by polyacrylic acid; or amine adducts, such as cycloaliphatic amine adducts and polyamine adducts.

In one or more particular embodiments, a diamine curing agent may be used. Non-limiting examples of diamine curing agents are aliphatic amines, such as triethylenetetramine (TETA, Formula V) or diethylenetriamine (DETA, Formula VI), aromatic amines, such as m-phenylenediamine (MDP, Formula VII) or methylenedianiline (MDA, Formula VIII), and cycloaliphatic amines, such as isophorone diamine (IPDA, Formula IX). Such diamines may be used alone or in combination.

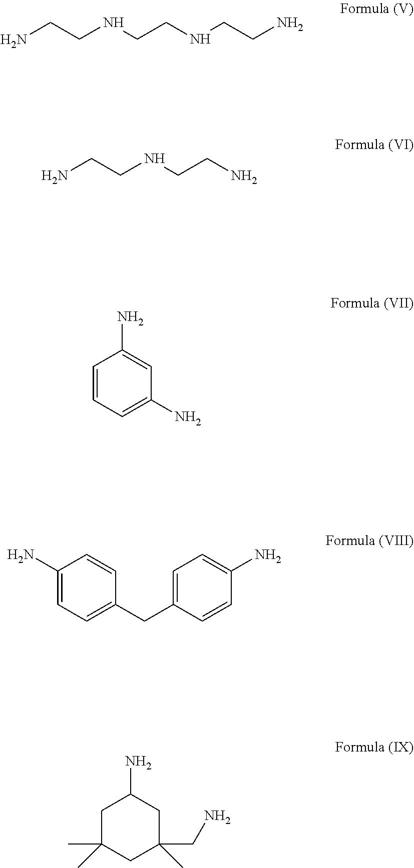

The curing agent may be included in a range of from about 0.5 to 10 wt. % of the curing agent based on the total weight of the polymer composite before curing. The curing agent in the epoxy resin system may have a lower limit of one of 0.5, 1.0, 1.5, 2.0, 2.5, 3.0, 3.5, and 4.0 wt. %, and an upper limit of one of 5.0, 6.0, 7.0, 8.0, 9.0 and 10.0 wt. %, where any lower limit may be paired with any upper limit.

As used throughout this disclosure, the term “cure” or “curing,” when used in the context of the epoxy resins and the polymer composites refers to the process of cross-linking the epoxy resin, which is in a liquid form initially, with a curing agent to form a solid cured epoxy polymer.

Polymer composites of one or more embodiments may include at least one cured epoxy polymer network. The at least one cured epoxy polymer network may include a plurality of covalent linkages (or “cross-links”) of at least one functional group of the epoxy resin, the functionalized inorganic filler, the amine curing agent, and combinations thereof. Examples of the plurality of covalently linked functional groups may be derived from epoxide rings, cyclic carbonate rings, amine groups, and combinations thereof.

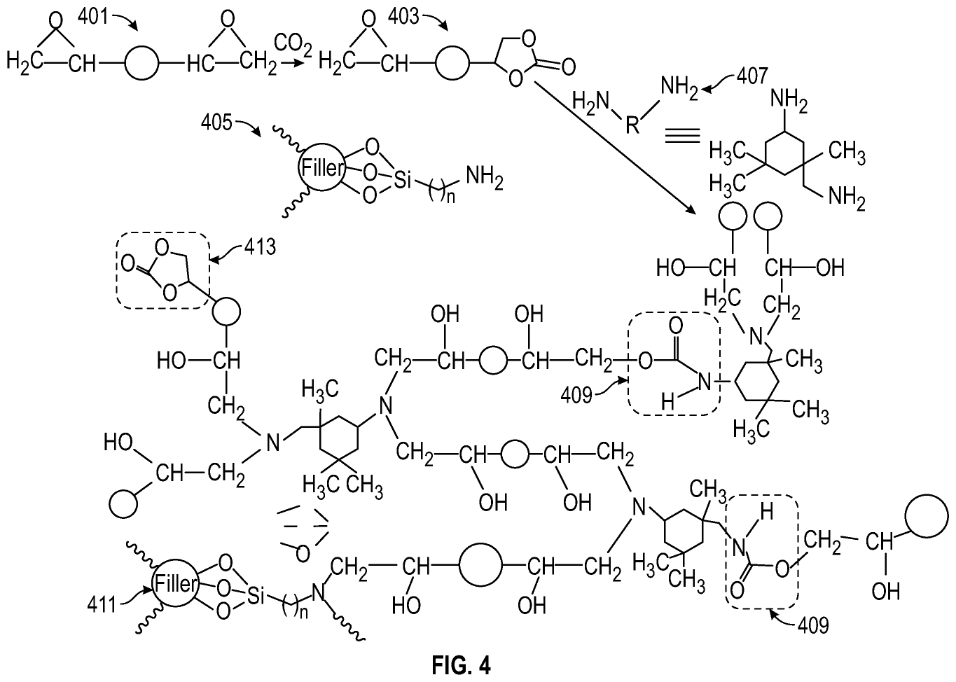

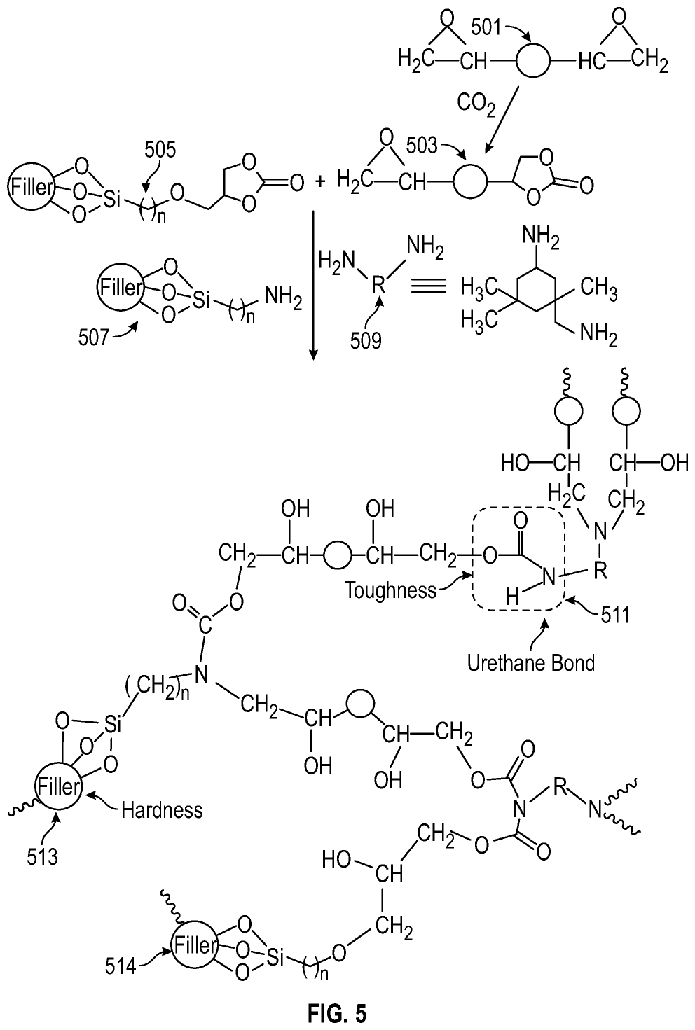

Covalent linkages may include at least one ether linkage, at least one carbonate linkage, at least one urethane linkage, and combinations thereof. The term “urethane linkage” refers to an isocyanate-free carbamate cross-link in the polymer composite. FIGS. 4 and 5 include a schematic of a cross-linked polymer composite in accordance one or more embodiments of the present disclosure.

In one or more embodiments, epoxy-based composites may also include cyclic carbonate inorganic fillers. The cyclic carbonate inorganic fillers may be included in addition to the functionalized inorganic fillers described above. A method for making the cyclic carbonate inorganic fillers includes reacting an epoxy silane with a cyclizing agent to form a cyclic carbonate silane-containing compound. The cyclizing agent may be any compound capable of reacting with the epoxy group of the epoxy silane to form at least one cyclic structure, and in particular embodiments, the cyclizing agent may be CO₂. In one or more embodiments, the epoxy silane may be selected from the group consisting of (3-glycidyloxypropyl) trimethoxysilane, (3-glycidyloxypropyl)triethoxysilane, (diethoxy 3-glycidyloxypropyl)methylsilane, and combinations thereof.

The method then includes mixing inorganic particles with at least one reactive compound to form a reactive mixture. In one or more embodiments the cyclic carbonate silane-containing compound is the at least one reactive compound. In such embodiments, the inorganic particles may be prepared via a hydrothermal process or obtained commercially. Any suitable hydrothermal method known in the art may be used to prepare the inorganic particles. The method further includes agitating and refluxing the reactive mixture to form the cyclic carbonate inorganic filler.

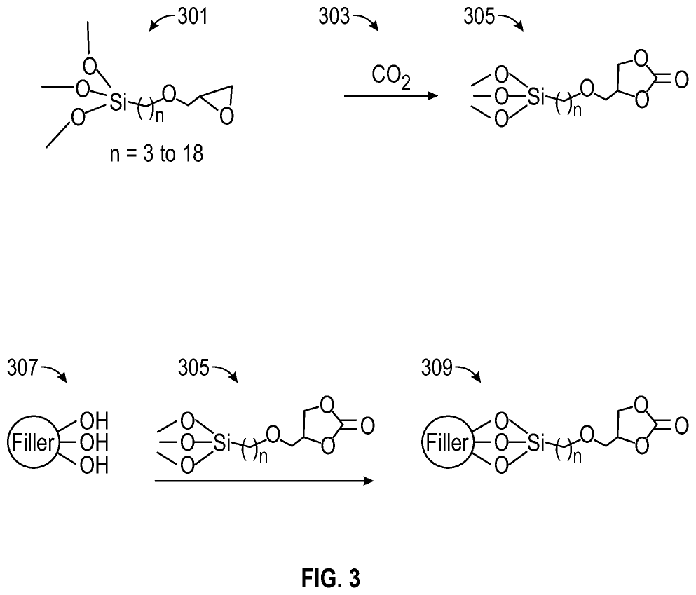

A reaction scheme in accordance with the previously described method of making the cyclic carbonate inorganic fillers is presented in FIG. 3. Epoxy silane 301, in particular (3-glycidyloxypropyl) trimethoxysilane, is reacted with carbon dioxide 303 as the cyclizing agent to produce a cyclic carbonate silane-containing compound 305. This cyclic carbonate silane-containing compound may then react with silica particles 307 via hydroxyl groups on the surface of the particles. Silica particles 307 may be dispersed in dry toluene via stirring at room temperature for a period of time, such as 30 minutes. The cyclic carbonate silane-containing compound 305 may then be added dropwise, forming the cyclic carbonate inorganic filler particles 309 after agitating and refluxing the reaction mixture in toluene for a period of time. The cyclic carbonate inorganic filler particles 309 may then be isolated, washed, and dried using methods known to those skilled in the art.

The cyclic carbonate inorganic filler may be included in the polymer composite in an amount ranging from 0.1 to 30 wt. % based on the amount of epoxy resin. The cyclic carbonate inorganic filler may be included in an amount having a lower limit of one of 0.1, 0.25, 0.5, 1.0, 2.0, 5.0, 10, and 15 wt. % and an upper limit of one of 10, 12.5, 15, 20, 25, 27.5 and 30 wt. %, where any lower limit may be paired with any mathematically compatible upper limit.

Polymer composites of one or more embodiments may have improved toughness and impact resistance compared to epoxy-based polymer composites not including a functionalized filler disclosed herein.

### Method of Forming a Polymer Composite

Embodiments of the present disclosure also include making polymer composites using the functionalized fillers of one or more embodiments to increase the toughness and impact resistance of the cured epoxy network by forming urethane linkages.

In such embodiments, the method for making the polymer composites may include introducing one or more epoxy resins to the functionalized inorganic particle (and optionally the cyclic carbonate inorganic filler) to form a first mixture. In such embodiments, the functionalized inorganic particle is as previously described. Then, at least one amine curing agent may be introduced to form a second mixture. The second mixture may then be cured for a period of time to form an epoxy crosslinked network. In such embodiments, the epoxy crosslinked network includes a plurality of urethane linkages.

In one or more embodiments, the functionalized inorganic fillers bearing reactive amine groups may be useful in epoxy-based composites. Such epoxy-based composites may include amine curing agents that will react with and crosslink epoxy resins. When amine curing agents are present, functionalized inorganic particles that can react with amines also become useful, such as epoxy and cyclic carbonate functionalized inorganic particles. Thus, in one or more embodiments, epoxy-based composites including the previously described functionalized inorganic fillers bearing reactive amine groups may incorporate amine curing agents, particles with other useful functionalizations such as epoxy and cyclic carbonate groups, and any other typical composite components and additives. In addition, the epoxy matrix may be modified to contain cyclic carbonate groups.

In one or more embodiments, an epoxy resin may be modified with a cyclizing compound to form a cyclic carbonate-containing epoxy matrix. In one or more embodiments, this may be done in the presence of the cyclizing compound such as carbon dioxide, as shown in FIG. 4.

FIG. 4 depicts forming a composite using an epoxy matrix that has been modified with carbon dioxide to contain cyclic carbonate groups, amine curing agents, and the functionalized inorganic filler. Epoxy resin 401 is exposed to CO₂, yielding a cyclic carbonate containing epoxy resin 403. The cyclic carbonate containing epoxy resin 403 can then be mixed with the functionalized inorganic filler 405 and amine curing agents 407. The amine groups on the surface of the functionalized inorganic filler and the amine curing agents react with the epoxy and cyclic carbonate groups to crosslink the cyclic carbonate containing epoxy resin 403 to form a crosslinked epoxy-based composite. In such a composite, the urethane bonds 409 provide toughness while the functionalized inorganic filler particles 411 provide hardness, leading to improved properties compared to epoxy resins crosslinked with amine curing agents alone. Unreacted carbonate groups 413 may also be present in the composite.

In one or more embodiments, incorporation of inorganic filler particles that are properly functionalized to crosslink within the epoxy structure may improve the physical and mechanical properties of the epoxy-based polymer composites. Applicable functionalizations may include but are not limited to amine, epoxy, and cyclic carbonate functionalizations. Epoxy-based polymers and composites can exhibit brittle physical properties, and the combination of the toughening effect of urethane bonds and the presence of the inorganic fillers may improve the physical properties of the composite, reducing the brittle behavior. Incorporation of functionalized inorganic fillers may also increase chemical and temperature resistance, as well as retard crack propagation. All these factors may increase the physical properties of epoxy composites when the functionalized inorganic fillers are included.

FIG. 5 depicts forming a composite using an epoxy matrix that has been modified with carbon dioxide to contain cyclic carbonate groups and amine curing agents, functionalized inorganic filler, and cyclic carbonate inorganic filler. Epoxy resin 501 is exposed to CO₂, yielding a cyclic carbonate containing epoxy resin 503. Epoxy resin cyclic carbonate 503 is combined with cyclic carbonate inorganic filler 505, functional inorganic filler 507, and amine curing agents 509. The amine curing agents 509 and the amine groups on the functionalized inorganic filler 507 react with the epoxy and cyclic carbonate groups to crosslink the cyclic carbonate containing epoxy resin 503 to form a crosslinked epoxy-based composite. In such a composite, the urethane bonds 511 provide toughness while the inorganic filler particles 513 and 514 provide hardness, leading to improved properties compared to epoxy resins crosslinked with amine curing agents alone.

In some embodiments, as depicted in FIG. 5, an epoxy resin 501, such as bisphenol A diglycydyl ether (DGEBA), may be exposed to CO₂ to form an epoxy resin cyclic carbonate 503. In particular, the epoxy resin may be reacted in a closed system such as an autoclave reactor pressurized with CO₂ gas. The reaction may be performed in a closed system under a pressure ranging from 150 to 600 psi (pounds per square inch). For example, the pressure exerted on the reaction with CO₂ gas may range from a lower limit of one of 150, 155, 160, 165, and 170 psi to an upper limit of one of 580, 585, 590, 595, and 600 psi, where any lower limit may be paired with any mathematically compatible upper limit.

The epoxy resin may be exposed to pressurized CO₂ gas at an elevated temperature for a sufficient amount of time to effectively form an epoxy resin cyclic carbonate 503, as depicted in FIG. 5. For example, in one or more embodiments, the reaction to form an epoxy resin cyclic carbonate is carried out at an elevated temperature ranging from 80 to 150° C. for 10 to 20 hours. The elevated temperature may range from a lower limit of one of 80, 90, 100, 110, and 120° C. to an upper limit of 110, 120, 130, 140, and 150° C., where any lower limit may be paired with any mathematically compatible upper limit. The reaction may be carried out for a sufficient amount of time ranging from a lower limit of one of 10, 11, 12, 13, 14, and 15 hours to an upper limit of one of 15, 16, 17, 18, 19, and 20 hours, where any lower limit may be paired with any mathematically compatible upper limit.

In one or more embodiments, a catalyst may be included in the reaction to form an epoxy resin cyclic carbonate. Suitable catalysts include, but are not limited to tetrabutylammonium bromide (TBAB), tetrabutylammonium fluoride (TBAF), tetrabutylammonium iodide (TRAI) with or without the presence of organic catalysts such as 1,3-Bis(2-hydroxyhexafluoroisopropyl)benzene, and combinations thereof.

Epoxy resin cyclic carbonates may be characterized according to various analytical techniques known in the art. For example, liquid and solid nuclear magnetic resonance (NMR), Fourier-transform infrared spectroscopy (FTIR), among others, may be used to characterize the prepared epoxy resin cyclic carbonates.

In one or more particular embodiments, the functionalized inorganic filler, the cyclic carbonate inorganic filler, the reactive compound, and combinations thereof may be mixed with at least one epoxy resin to form an epoxy resin mixture prior to the step of mixing the cyclizing agent as described above. In such embodiments, the epoxy resin of the epoxy resin mixture may include epoxy resins described above. In one or more particular embodiments, the epoxy resin may be selected from the group consisting of diglycidyl ether of bisphenol A, diglycidyl ether of bisphenol F, epoxy phenol novolac resins, and combinations thereof.

The polymer composite of one or more embodiments may have a cure time that enables the cross-linking, such as covalently linking, functional groups of the epoxy resin, the functionalized inorganic filler, cyclic carbonate inorganic filler, and combinations thereof to become a solid in the presence of the amine curing agent. In some embodiments, the curing step may include heating the second mixture for a period of time. In some embodiments, the cure time may be in a range of from about 0.5 to 12 hours. The term “cure time,” when used in the context of the epoxy resins and polymer composites in the present disclosure, refers to a time duration between a first time at which a curing agent is added to the epoxy resins and a second time at which the epoxy resin system has cured to form a solid epoxy.

### Example

### Materials

Tetraethyl orthosilicate, (3-glycidyloxypropyl) trimethoxy silane, (3-Aminopropyl)triethoxysilane, urea, hexadecyltrimethylammonium bromide, toluene and 1-pentanol were supplied by Sigma-Aldrich. Cyclohexane was supplied by Fisher Scientific.

### Methods

Silica particles were prepared by a hydrothermal process. A solution composed of tetraethoxysilane (20 g), cyclohexane (240 mL) and 1-pentanol (12 mL) was prepared and stirred for 30 minutes. Concurrently, an additional solution including cetyltrimethylammonium bromide (8 g), urea (4.8 g), and deionized water (240 mL) was mixed and stirred for 30 minutes at room temperature. The tetraethoxysilane solution was then added into the cetyltrimethylammonium bromide solution and stirred for 1 hour (h). The solution was then transferred into an autoclave and heated in an oven at 125° C. for 4 to 6 h. The autoclave was then gradually cooled, and the silica particles were collected by repeated centrifugation in deionized water and ethanol. After being dried overnight at room temperature, the synthesized powder was calcined under continuous air flow at 550° C. for 4 h yielding the silica particles as a pure white powder.

In a typical synthesis procedure for the functionalized inorganic filler, 10 g silica particles were dispersed in dry toluene and stirred for 30 min at room temperature. An aminosilane compound, specifically (3-Aminopropyl)triethoxysilane (30 mL) was added dropwise, and the resulting mixture was refluxed for 48 hours. The functionalized silica particles were then cooled to room temperature. After cooling, the functionalized silica particles were collected via repeated centrifugation and washed several times with toluene and ethanol to remove any unreacted (3-Aminopropyl)triethoxysilane. The modified silica particles were then dried at 120° C. for 4 h.

To prepare composite of bisphenol A diglycidyl ether (DGEBA)/Isophorone diamine (IPDA) and 3 wt. % of functionalized silica, 0.811 g of silica functionalized with amine derivative of (3-Aminopropyl)triethoxysilane is added into 4.82 g of IPDA and degassed under vacuum at room temperature. The resulting suspension was mixed with 21.87 g of DGEBA. The resulting mixture is then degassed under vacuum at room temperature and poured into a silicone mold, and left to cure for 24 h at room temperature. After curing, the mixture is post-cured at 80° C. for 4-5 hours.

### Applications in the Oil and Gas Industry

In one or more embodiments, the inorganic particle-containing epoxy-based composites described above may be useful for applications in the oil and gas industry. For example, they may be used in the manufacturing of fiber reinforced thermoset composites with enhanced toughness and fire resistance properties. The composites described above can be used as a coating or as a core building block of reinforced thermoset composite pipe (RTR) in both on-shore and off-shore applications. This includes, but is not limited to, water, gas, oil and condensate transportation pipes. Conventional thermosetting composites exhibit good chemical resistance and electrical insulation properties, yet, they lack fire retardancy and good impact resistance which hinder their wide utilization in oil and gas transportation. However, the polymer composites described herein provide the composite pipe with some flame retardancy characteristics and improved toughness. Therefore, incorporation of the above-described composites as a coating a core building block in RTR pipe may lead to enhanced properties and performance.

Embodiments of the present disclosure may provide at least one of the following advantages. Polymer composites described herein may provide enhanced toughness and flame retardancy performance via introduction of inorganic fillers and urethane bonds throughout a polymer matrix. The improvement of such properties in polymer composites may provide opportunity for the polymer composite material use in non-metallic pipelines inside plants as traditional reinforced thermoset resins possess modest toughness and poor fire resistance properties limiting them from such advanced applications and deployment. As such, advantages of the improved properties may qualify polymer composites of one or more embodiments for use in reinforced thermoset resin pipes, building materials, and construction coatings, among others.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A functionalized inorganic filler comprising:
an inorganic particle comprising a surface functionality, wherein the surface functionality is at least one amine group linked to a surface of the inorganic particle, wherein the inorganic particle comprising a surface functionality is formed from a reaction between an inorganic particle and an aminosilane compound.

2. The functionalized inorganic filler of claim 1, wherein the inorganic particle is selected from the group consisting of a silica particle, a titanium dioxide particle, a zinc oxide particle, a zirconium dioxide particle, and combinations thereof.

3. The functionalized inorganic filler of claim 2, wherein the inorganic particle is silica.

4. The functionalized inorganic filler of claim 2, wherein the inorganic particle has a shape selected from the group consisting of a sphere, a tube, a lamella, a rod, a dendrite, a fiber, and combinations thereof.

5. The functionalized inorganic filler of claim 1, wherein the inorganic particle has a diameter in the range of 15 to 500 nm.

6. The functionalized inorganic filler of claim 1, wherein the aminosilane compound is selected from the group consisting of 4-amino-3,3-dimethylbutyl trimethoxysilane, m-aminophenyl trimethoxysilane, 3-aminopropyl triethoxysilane and 3-(m-aminophenoxy) propyl trimethoxysilane, and combinations thereof.

7. A method of making a functionalized inorganic filler, the method comprising:
providing inorganic particles with at least one aminosilane compound to form a reactive mixture; and
agitating the reactive mixture to form the functionalized inorganic filler.

8. The method of claim 7, wherein the agitating further comprises heating the reactive mixture.

9. The method of claim 7, wherein the at least one aminosilane compound is selected from the group consisting of 4-amino-3,3-dimethylbutyl trimethoxysilane, m-aminophenyl trimethoxysilane, 3-aminopropyl triethoxysilane and 3-(m-aminophenoxy) propyl trimethoxysilane, and combinations thereof.

10. The method of claim 7, wherein the inorganic particles comprise an inorganic material selected from the group consisting of silica, titanium oxide, zinc oxide, zirconium oxide, and combinations thereof.

11. A polymer composite comprising:
an epoxy-based polymer matrix; and
a functionalized inorganic filler comprising an inorganic particle comprising a surface functionality, wherein the surface functionality is at least one amine group linked to a surface of the inorganic particle, wherein the inorganic particle comprising a surface functionality is formed from a reaction between an inorganic particle and an aminosilane compound.

12. The polymer composite of claim 11, wherein the aminosilane compound selected from the group consisting of 4-amino-3,3-dimethylbutyl trimethoxysilane, m-aminophenyl trimethoxysilane, 3-aminopropyl triethoxysilane and 3-(m-aminophenoxy) propyl trimethoxysilane, and combinations thereof.

13. The polymer composite of claim 11, wherein the epoxy-based polymer matrix further comprises cyclic carbonate groups formed between the reaction of the epoxy-based polymer matrix and a cyclizing compound.

14. The polymer composite of claim 13, wherein the cyclizing compound is carbon dioxide.

15. The polymer composite of claim 11, wherein the epoxy-based polymer matrix is selected from the group consisting of diglycidyl ether of bisphenol A, diglycidyl ether of bisphenol F, an epoxy phenol novolac resin, and combinations thereof.

16. The polymer composite of claim 11, wherein the polymer composite further comprises an amine curing agent.

17. The polymer composite of claim 16, wherein the amine curing agent is selected from the group consisting of triethylenetetramine, diethylenetriamine, m-phenylenediamine, methylenedianiline, isophorone diamine, and combinations thereof.

18. The polymer composite of claim 11, wherein the functionalized inorganic filler is present in an amount ranging from 0.1 to 30 wt. % (weight percent) based on an amount of the epoxy-based polymer matrix.

19. The polymer composite of claim 11, wherein the polymer composite further comprises inorganic particles comprising a surface functionality, wherein the surface functionality is at least one reactive cyclic carbonate group linked to a surface of the inorganic particles.

20. A reinforced thermoset composite pipe comprising the polymer composite of claim 11.
